(19) United States
(12) Patent Application Publication
(10) Pub. No.: US 2021/0365771 A1
(43) Pub. Date: Nov. 25, 2021

(54) OUT-OF-DISTRIBUTION (OOD) DETECTION BY PERTURBATION

(71) Applicant: International Business Machines Corporation, Armonk, NY (US)

(72) Inventors: Skyler Speakman, Nairobi (KE); Celia Cintas, Nairobi (KE); Victor Abayomi Akinwande, Karen (KE); Komminist Weldemariam, Ottawa (CA)

(21) Appl. No.: 16/880,147

(22) Filed: May 21, 2020

(51) Int. Cl. G06N 3/08; G06N 3/04

(52) U.S. Cl. CPC G06N 3/08; G06N 3/04

(57) ABSTRACT

Improved quantification, detection, and characterizing of out-of-distribution (OOD) of a set of inputs that are generated by an alternative process such as anomalies, outliers, adversarial attacks, input errors can be provided with a combination of detection under perturbations and subset scanning algorithms. A first set of activations is extracted from nodes in a hidden layer of a neural network for an input. Noise is added to the input. A second set of activations is extracted from nodes in the hidden layer of a neural network for the noised input. A difference between the first set of activations and the second set of activations is determined. The difference is compared with a difference computed using in-distribution samples. Based on the comparison, an anomaly score for the input is determined. Multiple inputs can be processed. An iterative ascent algorithm finds out-of-distribution input and internal nodes with anomalous activations.

### BACKGROUND

The present application relates generally to computers and computer applications, and more particularly to machine learning and neural networks.

Machine learning allows computer systems to learn, for example, from data, and make decisions such as classifications and predictions. In real-world machine learning applications, large outliers and pervasive noise can occur, and access to clean training data as required by standard deep neural models may not be easy. Inventors in the present disclosure have recognized that reliably detecting anomalies, e.g., including group-based anomalies in a given set of input such as images or other types of inputs is a task of a practical relevance in many areas such as, but not limited to, visual quality inspection, surveillance, and/or medical image analysis.

### BRIEF SUMMARY

A computer-implemented method and system, which can detect out-of-distribution data or event in machine learning, can be provided. A method, in one aspect, can include extracting a first set of activations from nodes in a hidden layer of a neural network for an input. The method can also include adding noise to the input. The method can further include extracting a second set of activations from the nodes in the hidden layer of the neural network for the noised input. The method can also include determining a difference between the first set of activations and the second set of activations at the nodes. The method can also include comparing the difference with a difference computed using in-distribution samples at the nodes. The method can also include determining an anomaly score for the input based on the comparison.

A system, in one aspect, can include a hardware processor and a memory coupled with the hardware processor. The hardware processor can be configured to extract a first set of activations from nodes in a hidden layer of a neural network for an input. The hardware processor can also be configured to add noise to the input. The hardware processor can also be configured to extract a second set of activations from nodes in the hidden layer of a neural network for the noised input. The hardware processor can also be configured to determine a difference between the first set of activations and the second set of activations. The hardware processor can also be configured to compare the difference with a difference computed using in-distribution samples. The hardware processor can also be configured to determine an anomaly score for the input based on the comparison.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIGS. 1A-1, 1A-2, and 1A-3 illustrate an approach disclosed herein in an embodiment.

FIGS. 1B-1 and 1B-2 show another example scenario in an embodiment.

FIG. 2 illustrates characterizing groups of images in embodiments.

FIG. 3 is a diagram illustrating a method in one embodiment.

FIG. 4 is a diagram illustrating system components and dataflow, according to some embodiments.

FIG. 5 is a flow diagram illustrating a method in one embodiment.

FIG. 6 is a diagram showing components of a system in one embodiment.

FIG. 7 illustrates a schematic of an example computer or processing system that may implement a system in one embodiment.

### DETAILED DESCRIPTION

Methods, systems and techniques are described for improved quantification, detection, and characterizing of out-of-distribution (OOD) of a set of inputs that are generated by an alternative process such as anomalies, outliers, adversarial attacks, human input errors, using a combination of detection under perturbations and subset scanning algorithms. By way of example, OOD detection of can improve machine learning and training, and also improve the quality of a machine learning model that is generated, for example by providing or generating a cleaner training data set. Detection of OOD can also improve computer security by accurately detecting adversarial attacks.

An artificial neural network (ANN) or neural network (NN) is a machine learning model, which can be trained to predict or classify an input data. An artificial neural network can include a succession of layers of neurons or nodes, which are interconnected so that output signals of neurons in one layer are weighted and transmitted to neurons in the next layer. A neuron Ni in a given layer may be connected to one or more neurons Nj in the next layer, and different weights wij can be associated with each neuron-neuron connection Ni-Nj for weighting signals transmitted from Ni to Nj. A neuron Nj generates output signals dependent on its accumulated inputs, and weighted signals can be propagated over successive layers of the network from an input to an output neuron layer. An artificial neural network machine learning model can undergo a training phase in which the sets of weights associated with respective neuron layers are determined. The network is exposed to a set of training data, in an iterative training scheme in which the weights are repeatedly updated as the network “learns” from the training data. The resulting trained model, with weights defined via the training operation, can be applied to perform a task based on new data. Activation data refers to an output signal generated by a neuron or node of a neural network, for example, an output of an activation function of the neuron, which for example, indicates which internal neurons or nodes are activated.

Neural networks generate a large amount of activation data in processing an input. In embodiments, systems and methods can apply one or more anomalous pattern detection techniques on this activation data in order to determine if the input is anomalous. Examples of an anomalous input can be, but not limited to, noised samples input by an adversary and human annotation, and other alternative processes. The anomalous pattern detection may quantify, detect, and characterize the data that are generated by an alternative process (e.g., anomalies, outliers, adversarial attacks, human input errors). Since anomalies may not occur regularly and they may originate from diverse sources, it may not be feasible to obtain labeled datasets of all possible anomalies and/or attacks.

Systems and methods in embodiment may provide the ability to detect group anomaly in neural networks; ability to detect anomalous activity at perturbation level when they persist across multiple inputs; ability to provide to end users information regarding which samples are anomalous and information of which parts or nodes of the model make the group of samples anomalous and offer retraining techniques for robustness purposes on the existing models; ability to connect the anomaly detection process to an anomalous pattern spanning a group of inputs.

A process of a system and/or method described herein allows a neural network to “know when it does not know”. That is, the neural network can raise an alarm when a group of inputs (e.g., images, audio) does not match what the neural network would normally expect to see. The process can also provide the ability to detect these anomalous patterns, e.g., persisting across multiple inputs.

Anomalies can arise in multiple situations. For instance, adversarial noise can be detected, where an attacker has made slight alterations to the input in order to intentionally trick the network (e.g., neural network) into providing the wrong response. A system and/or method (referred to as a methodology for simplicity) in an embodiment can allow the network to detect which group of input (e.g., images, audio) appear to be corrupted. This can be relevant where an attacker is noising multiple inputs such as multiple images. Examples of input or input data are described with respect to images. However, other types of data can apply such as, but not limited to, audio data, video data, text data, media data and/or others.

As another example, a new class label can be detected. Consider a system (e.g., a neural network) designed to classify cancer types. The system may do very well on five known classes (with provided labeled data) but not so with examples of a sixth class appearing in the data. A methodology described herein in an embodiment can allow the network to present to a human researcher the example data or input (e.g., images) that the network determines are most different from the input data (e.g., images) the network has been trained on.

As another example, out-of-distribution samples can be detected more generally. For example, there can be simple mistakes in data streams where completely different samples are provided to a neural network, for instance, unintentionally, or to reflect a new trend. Such example may be relevant for simple data flow checking.

The system and/or method in an embodiment may provide for improved detection and scoring of anomalous behavior of current neural networks, e.g., without requiring any retraining. The system and/or method in an embodiment can use a combination of detection under perturbations and subset scanning algorithms. In another aspect, the system and/or method may also inspect and visualize the set of anomalous nodes in the activation space that make a set of samples noised.

In an embodiment, a system disclosed herein uses a unified framework for detecting “Out of Distribution” (OOD) samples and adversarial attacks. For example, the system adds directed perturbations to the input (e.g., slight changes to the pixels of an image) and then checks or observes how the network activations change in response to these perturbations. Some pixel perturbations applied to in-distribution images (e.g., images that are not adversarially noised or images that are from a known class) make larger changes in the activations of the network. When similar perturbations are applied to out-of-distribution images (e.g., images that are adversarially noised or images that are from an unknown class), they make smaller changes in the activation of the network. This measure of change in the activations under the presence of perturbations is then used to determine if the input image is “normal” or not. In an embodiment, the system measures changes in the activations under the presence of a perturbation and can determine which individual features of the image respond to the perturbation, and also can measure the change experienced by multiple images.

In an embodiment, the system allows for the detection to be both more specific (e.g., by identifying activations and/or features of the neural network have anomalous responses to the perturbation), and more general (e.g., by identifying a group of images that have this same anomalous response at the same group of features).

In an embodiment, detecting which subset of features or nodes of a neural network are anomalous for which subset of images, uses a Fast-Generalized Subset Scan for Anomalous Pattern (FGSS) Detection algorithm. The FGSS can be used for identifying an anomalous subset of inputs “crossed with” their anomalous subset of attributes. The system disclosed herein extends the FGSS to scan multimedia (e.g., images, audio) data beyond tabular data. Briefly, the tabular data uses inputs as rows of a table and attributes as columns of a table. More specifically, the system efficiently maximizes a non-parametric scan statistic (NPSS) through an iterative ascent procedure. This is done by: for this given subset of nodes, identifying the most anomalous (highest scoring) subset of images; and then, for this given subset of images, identifying the most anomalous (highest scoring) subset of nodes. The system further alters p-values, which get fed into an optimization process. The optimization process can be an iterative ascent procedure where the system iterates between nodes->images->nodes->images. This way, the approach disclosed herein can be generalized to records as images and attributes as neural network activations. For instance, FGSS uses tabular data where a record (row) has attributes (columns). The system in embodiments treats an image as a ‘row’ of the FGSS framework and each node activation as a ‘column’. Briefly, in hypothesis testing and normal distribution, the p-value provides information on the probability of observations, given that the null hypothesis is correct. If the p-value is lower than a pre-defined number, the null hypothesis is rejected, the result is determined to be statistically significant and that the alternative hypothesis is true.

For instance, if there are no abnormalities in input data (e.g., “the null hypothesis is true”) then new data points should “look like” old data points. The system in an embodiment quantifies how different data points are away from expected values using non-parametric scan statistics. The non-parametric part implies that the system does not make assumptions about the distribution of the data (e.g., it is normal, or Poisson, or Binomial). Instead, for example, the system compares new data points with old data points and quantifies the difference with a p-value. If a new data point is larger than 97% of the old data points than the new data point gives a p-value of 0.03. According to a theorem in statistics, if the new data points are pulled from the same distribution as the old data points then the p-values will be uniformly distributed. However, if new data points are pulled from a different distribution than the old data points then the p-values will not be uniformly distributed. The scan statistics quantifies how non-uniform the new data is when compared to the old data. Specifically, it looks for groups of records that have a larger number of smaller p-values. In an embodiment, using this technique, the system looks for a group of images x nodes (images “crossed with” nodes, e.g., which images and which nodes) that have larger activations than expected.

In an aspect, the search space is very large, e.g., 2\hat{ }num images×2\hat{ }num nodes, “\hat{ }” representing “exponent” or “power” function. The search space includes the number of neural network's internal or hidden nodes, and each input (e.g., each image or another data such as audio data) run through the neural network includes the number of internal nodes. The system in an embodiment explores this space, looking for the combination of images x nodes that have their activations larger than expected. For example, the system looks for small p-values, e.g., p-values smaller than a predefined threshold. In this way, the system can find a distribution of p-values that looks non-uniform. This is also referred to as maximizing a non-parametric scan statistic.

An iterative process decomposes the problem into alternating optimization steps. In an embodiment, the iterative ascent algorithm can be used. For a given set of images, the system can identify the subset of nodes that have high activations (these nodes are the ones that maximize the NPSS). For the subset of nodes, the system can then identify the subset of images that have high activations. This process repeats until it converges. For example, the subset of images and nodes no longer change at each optimization step (each iteration).

By way of example, in the first pass through the process, the subset of node (or images) can be random. Each iteration after the first pass uses the subset of nodes that were most anomalous for previous subset of images. This iterates back and forth until convergence, e.g., nodes->images->nodes->images->nodes->images.

A node in the network generates an activation every time the network (neural network) processes an image. The system observes the network processing a large number of images (for example, 9,000 images). In this example, therefore, each node now has 9,000 activations that occur under “normal” or “in-distribution” images.

Following with the above example, when a new image (or group of images) comes in to the network, the system compares the activation generated by the new image against the 9,000 activations generated by “normal” images. The p-value corresponds to, which proportion of the 9,000 activations are larger than the activation from the new image. For example, if the new image generates an activation that is larger than 96% of the 9000 activations, the p-value is 0.04.

By way of an example, the system can add small, controlled perturbations to the pixels of the input images and measure how individual activations of the neural network change and/or not change in response to that stimulus. For example, the system can introduce response activation subset scan (RASS), in which the system looks for features (e.g., node activations) that have an anomalous response due to the noise added to the input. The system then can evaluate how multiple images respond, at the individual activation node level, when under these controlled perturbations. This way, the system can define anomalousness at the “subset of nodes” level, e.g., rather than at the input (pixel) or output (class label) levels.

In the method described above, a p-value is generated by comparing a raw activation of an image against raw activations from a large number of “normal” images. In an embodiment, in response activation subset scan (RASS), the system may no longer use the raw activation of the image experienced by the node. Instead, the system perturbs the image by adding some noise to the pixels of the image. These small perturbations of the pixels generate changes in the activations in response. The system records the change (delta) in activation between an unperturbed image and a perturbed image.

For example, consider 9,000 “normal” images. Each node has 9,000 “raw” activations. In RASS, the system in an embodiment perturbs each of the 9,000 images and records the deltas at each node that occur in response to the perturbation. When a new image comes in, e.g., a new image or a set of new images are run through a neural network, the system records the raw activations of internal nodes of the neural network, which is run with the new image. The system perturbs the new image. The system records the perturbed activation at each node. The system then records the difference (delta), which represents a change in activation between the unperturbed new image and perturbed new image at each node. The system compares this observed delta from the new image to the 9,000 deltas from the “normal” images. This now returns to the original definition of p-values from above. If the new image experiences a large delta as compared to the 9,000 background images, then that image-node combination would have a small p-value. For example, the p-value corresponds to, which proportion of the 9,000 activation deltas are larger than the activation delta from the new image. For example, if the new image generates an activation delta that is larger than 96% of the 9,000 activations, the p-value is 0.04.

The following illustrates another example. Consider a 512-dimensional space, e.g., the number of nodes in the deepest layer of a neural network is 512, sometimes also called the feature space or representation space. Each 512 feature has a real value. This is the “activation” of the node. The system induces a change in the image, by adding noise, and records a delta at each node. This delta represents how that node responded to the change.

Some deltas may be large, some may be small or 0. For a given image, the system converts each delta into a p-value. The system can perform a right-tailed p-value and/or a left-tailed p-value. In a right-tailed p-value, a value of 0.025 means that only 2.5% of the other deltas were larger than this one. In a left-tailed p-value, a p-value of 0.03 means that only 3% of the other deltas were smaller than this one.

From the non-parametric subset scanning under the null hypothesis that the input is “in-distribution”, the p-values from these 512 activations should be uniformly distributed. This is equivalent to stating that the deltas observed on this image “look like” the deltas observed on 1000+ previous examples where it is known how clean images “responded”.

The alternative hypothesis is that for some subset of features or nodes this particular image is generating responses that “do not look like” the responses generated by clean images. This implies that there are a larger number of low p-values than what would be expected under a uniform assumption.

Thus, by using non-parametric scan statistic (NPSS) scoring functions, the system can quantify how much the observed p-values (e.g., in 512-dimension space in the above example) differ from uniformly distributed p-values.

This score can be thought of as how much “evidence” there is for the alternative hypothesis. A higher score means the method found a subset (i.e., a combination of images×nodes) that had a larger number of smaller p-values than would be expected. Images×nodes represents a search space of images and nodes. If there are 100 images and 2000 nodes, then there are 2\hat{ }100 possible ways to subset the images and 2\hat{ }2000 ways to subset the nodes. The search space, for example, is the combination across the two (images and nodes), for example, which subset of images crossed with which subset of nodes generate small p-values (which represents the larger-than-expected activations).

In another embodiment, in addition to scoring individual inputs, the system can further efficiently score a group of inputs to identify anomalous node changes that span multiple inputs. This can be useful in cases in which an attacker is changing multiple images to the same target label or if examples of a “new class” are becoming more common and not a ‘one-off’.

Table 1 shows an example illustrating individual detection power and group based Area Under the Receiver Operating Characteristics (AUROC) values in one embodiment. AUROC provides evaluation metrics for checking any classification model's performance.

TABLE 1

| BIM | | | | | | |
|---|---|---|---|---|---|---|
| (ϵ = 0.02) | Detection Power (AUROC) | | | | | |
| Target | | Proportion of noised images in the 500 image test set | | | | |
| Class | Ind. | 6% | 8% | 10% | 12% | 14% |
| 0 | 0.856 | 0.794 | 0.885 | 0.978 | 0.999 | 1.000 |

AUROC is area under the ROC curve. It is a measure of how well the method is able to identify “anomalous” images from “clean or normal” images. A value of 1.0 means the method can perfectly identify/separate between anomalous and non-anomalous images. A value of 0.5 means the method is no better than random guessing. If the system looks at images individually (not as a group of multiple images) then the AUROC is 0.856. Detection power may be demonstrated when scanning over groups of images. The tests examine groups of 500 images. An example of image mix includes 10% of the 500 images which are anomalous images and 90% which are clean (non-anomalous) images. In this example 10% setting, AUC is at 0.978.

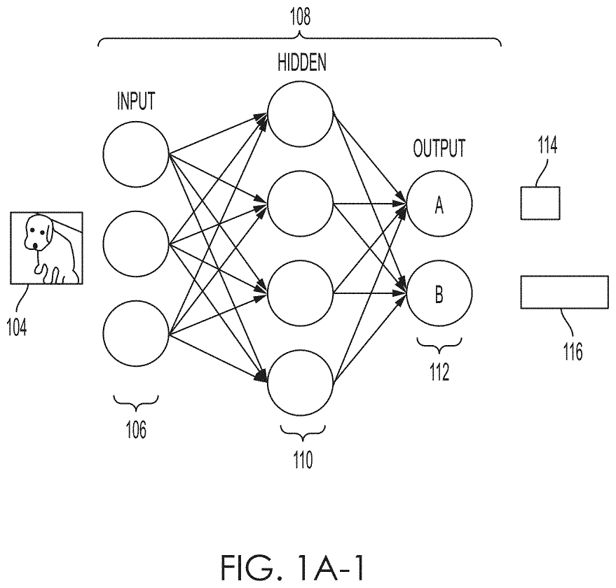

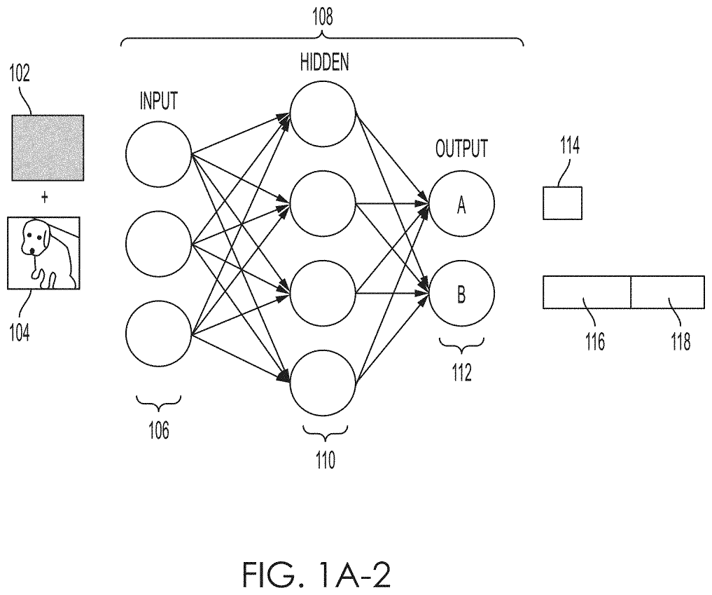

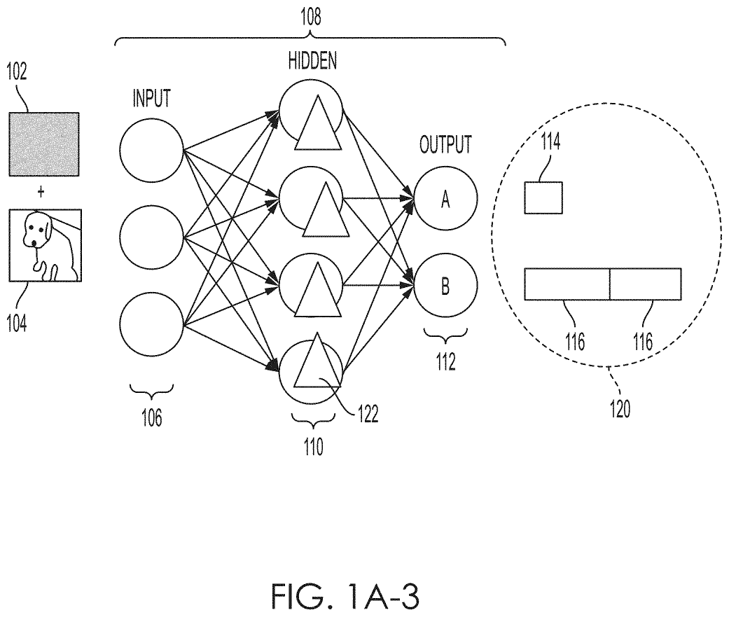

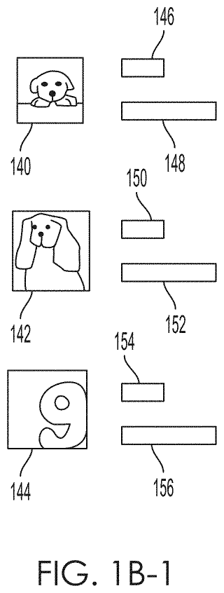

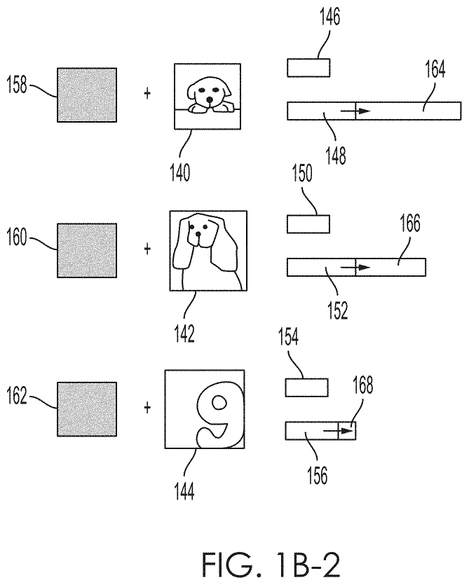

FIGS. 1A-1, 1A-2, and 1A-3 illustrate an approach disclosed herein in one embodiment. Referring to FIG. 1A-1, input data 104 such as an image (e.g., in this example, an image of a dog) can be input to an input layer 106 of a trained neural network 108. For instance, the neural network 108 is one that is trained to classify an image such as a dog. The bars 114, 116 represent the output (logits) of the neural network 108 on whether or not the neural network 108 estimates that the input image 104 is of a dog or has a dog in the image. By way of example, the bars 114, 116 represent the soft-max output from the neural network 108. In this simplified setting the output is trying to determine if the picture has a dog or not. The bar 114 represents “no dog” output; the bar 116 represents “dog” output. For instance, because the bar 116 is longer than the bar 114, the network decides or thinks that there is a dog in the input image 104. For instance, the image 104 is passed through the neural network 108, which outputs its classification or prediction 112.

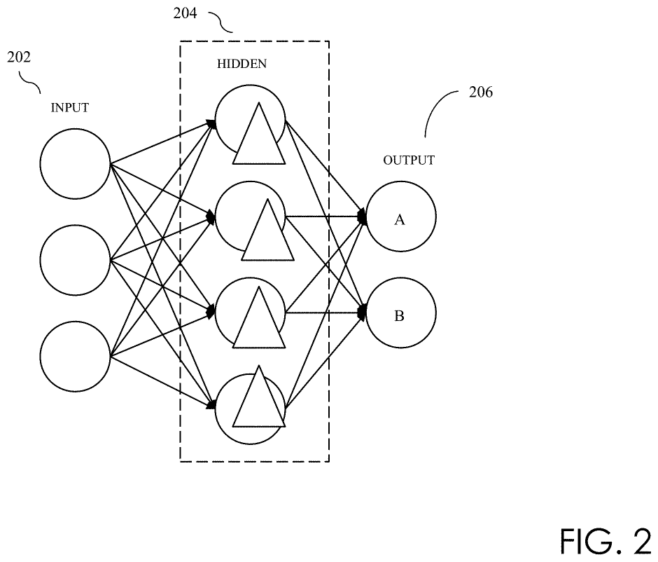

Referring to FIG. 1A-2, noise or distortion 102 is added to the image data 104. For example, perturbations to the pixels of the original dog image 104 are added. The noised image (102+104) is passed through the neural network 108. The perturbations are designed so that the network becomes more confident that there is a dog in the image. This is shown by the increase in length of the output of the “dog” answer at 118. Adding the perturbations increases the logit of the dog class, e.g., increases the confidence level of the neural network classifying that there is a dog in the image. The additional bar 118 emphasizes how much the addition of perturbation changes the output of the network.

Referring to FIG. 1A-3, a system and/or method in an embodiment disclosed herein need not observe the change of the logits 120 that was induced by the perturbation. In an embodiment, the system and/or method observe the change among the internal nodes 110 of the neural network 108 (changes shown by the deltas 122 over the nodes 110). In embodiments, the system and/or method may observe those changes by implementing an iterative ascent algorithm such as fast generalized subset scan (FGSS). In embodiments, the system and/or method add perturbations 102 to an image 104. In embodiments, the system and/or method need not observe the response of those perturbations in the final or output layer (logits) 112 of the neural network 108. In embodiments, the system and/or method observes the response to the perturbation in the internal representation or nodes 110 of the neural network 108. The system and/or method in embodiments may look for patterns of changes in internal layers 110. Some features (node activations at internal nodes 110) may be more susceptible than others. The method and/or system identify subset of anomalous node-changes.

In an embodiment, observing or detecting larger activations (e.g., activations greater than a threshold level) at a node (hidden or internal nodes) can determine adversarial noise setting, in which the data is intentionally hacked to trick the classifier. “Out-of-distribution” (OOD) setting can also be defined as detecting a class of images that the network has not seen or observed previously, regardless of whether the detected out-of-distribution data is adversarial or not. In this setting, for example, an “anomalous” image may generate very similar raw activations as in-distribution or normal images. However, responsive to adding perturbations, the anomalous image responds very differently than normal images. In embodiments, this allows the system to detect the anomalous image.

FIGS. 1B-1 and 1B-2 show another example scenario in an embodiment. For example, the 2 bars 146, 148, 150, 152, 154, 156 next to each image 140, 142, 144 represent the output of a neural network on whether or not the neural network estimates that there is a dog in the picture. For example, the bar on top 146 (also 150 and 154) represents “no dog”; the bar on the bottom 148 (also 152, 156) represents “dog”. Because the bar on the bottom (e.g., 148) is longer than the bar on the top (e.g., 146), the neural network thinks that there is a dog in the image. In this figure, the neural network is “correct” for the 2 dog images 140, 142 but is wrong for the third image 144 which is actually a picture of a digit “9”.

Referring to FIG. 1B-2, noise 158, 160, 162 is added to each image 140, 142, 144. For example, perturbations can be added to the pixels of the original dog image. These perturbations are designed so that the network becomes more confident that there is a dog in the image. This is shown by the increase in length of the output 164, 166 of the “dog” answer. Adding the perturbations increases the logit of the dog class. For instance, adding the perturbations increases the confidence of the neural network in its classification result that a dog is detected in the image. In the third image 162, the noise 162 added to that image 162, which the neural network originally classified the image as an image of a dog (incorrectly classified), only produces a small change 168 in the logit of the neural network. An actual or real image of a dog experiences a larger amount of change in the output layer as shown at 164 and 166. Shown at 168, an out-of-distribution image that happens to be accidentally labeled as a dog, experiences smaller amount of change in output layers.

FIGS. 1B-1 and 1B2 show starting with an image, observing the output of a neural network (logits). Perturbations to the pixels of the image can be added and the change in the logits can be observed. In an aspect, if the change is above a threshold, the original image can be determined to be “in-distribution”. If the logits do not change much under perturbation (e.g., by comparing to a threshold) then it may be determined that the original image is “out-distribution”.

The top two rows (140, 142) have images of dogs. The bars 146-156 beside each picture represent the probability that the network (e.g., the neural network) estimates that there is a dog in the image or not. The system adds noise/perturbations to the dog images. When this noise is added, the network becomes strongly convinced that the image has a dog (this is represented by increased bars 164, 166, 168, which have increased under the presence of the perturbation).

The third image144 represents an OOD image, which is an example of an image from a completely different set of data (digits) and not related to dogs. The network's output may indicate low probability as to classifying what it is, e.g., shown by the bar at 156. When the digit image has perturbations added to it, the output does not change much, e.g., shown by the extension of the bar at 168. This is because it is difficult to make an image of digit ‘9’ look like an image of a dog. This lack of response in the presence of perturbation signals that this image may be OOD. In an embodiment, a system and/or method disclosed herein need not observed the outputs to determine OOD input, but can observe the internal nodes or activations at the internal nodes to determine OOD input.

In another aspect, the system and/or method can detect above-described changes due to perturbation across a group of images. For example, the system and/or method in an embodiment can provide a group OOD detection, e.g., by perturbation. For example, the system and/or method can look for a systematic change that persists across multiple images due to the perturbation. Such detection can aid in scenarios where there are multiple out-of-distribution samples occurring, for example, in a computer system under attack.

FIG. 2 illustrates characterizing groups of images in embodiments. A neural network includes input nodes 202, hidden layer nodes 204 and output nodes 206. A hidden layer of a neural network includes a layer between an input layer and an output layer. A hidden layer is also referred to as an internal layer. There can be multiple hidden layers. The number of hidden layers and the number of nodes at each hidden layer can vary. FIG. 2 shows a simple example with a hidden layer for simplicity of explanation. Referring to FIG. 2, an input to a neural network is represented by a vector of length N which is the number of nodes being evaluated. For instance, the number of nodes may be on the order of 1000's. Each entry in the vector is the change that node experienced. For example, each image has perturbations added. The system records the activation at each node for the perturbed and un-perturbed images. The difference between the activations of the perturbed and un-perturbed values represents the response of the activation due to the perturbation that was added. The system may efficiently identify which subset of nodes at 204 experience a larger-than-expected change or smaller-than-expected change. The system can quantify how large of a difference these deltas are. This is an anomaly “score” of the input which can be used to inform users. The system also characterizes and reports which nodes were responsible for that score. This can be used for further inspection to help characterize the type of anomaly.

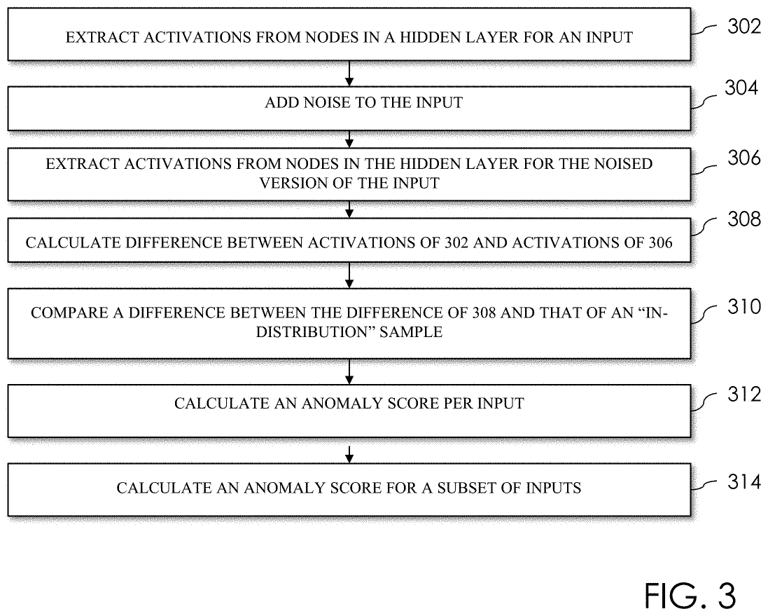

FIG. 3 is a diagram illustrating a method in one embodiment. The method can be implemented on or by one or more processors such as hardware processors. One or more processors or hardware processors, for example, may include components such as programmable logic devices, microcontrollers, memory devices, and/or other hardware components, which may be configured to perform respective tasks described in the present disclosure. Coupled memory devices may be configured to selectively store instructions executable by one or more hardware processors.

A processor may be a central processing unit (CPU), a graphics processing unit (GPU), a field programmable gate array (FPGA), an application specific integrated circuit (ASIC), another suitable processing component or device, or one or more combinations thereof. The processor may be coupled with a memory device. The memory device may include random access memory (RAM), read-only memory (ROM) or another memory device, and may store data and/or processor instructions for implementing various functionalities associated with the methods and/or systems described herein. The processor may execute computer instructions stored in the memory or received from another computer device or medium.

At 302, the method includes extracting activations from nodes in a hidden layer of a neural network for each input. The neural network can be run with input, which then generates activations at the nodes of one or more hidden layers. Those activations can be extracted. As an example, an input can be a data set representing an image or another media. The input can be an unperturbed input, e.g., also referred to as a “clean” input. There may be multiple hidden layers, in which case activations from nodes in all hidden layers can be extracted. This set of activations is referred to as a first set of activations.

At 304, the method includes adding a noise to the input. For instance, the noise distorts a clean input such as distorting an image, an audio, or another input data.

At 306, the method includes extracting activations from nodes in the hidden layer for the noised version of the input. For instance, the neural network can be run with noised input, which then generates activations at the nodes of one or more hidden layers. Those activations can be extracted. This set of activations associated with the noised version is referred to as a second set of activations.

At 308, the method includes calculating a difference between the first set of activations and the second set of activations. For instance, for each node, a difference is computed between its activation associated with the input and the noised input.

At 310, the method includes comparing the differences computed at 308 with the differences observed in preprocessing or offline of “in-distribution” samples. For example, a plurality of data sets representing “in-distribution” samples may be preprocessed by extracting activations of un-perturbed and corresponding perturbed samples. For instance, the neural network can be run with those “in-distribution” samples as inputs, which generates activations at nodes of one or more hidden layers of the neural network. Those activations can be extracted. The differences of the activations for each of the plurality of data sets (samples) are recorded and used in this comparison at 310. “In-distribution” samples are those considered to be clean or known to be clean, for example, reflect or contain what is expected of the samples. In an embodiment, such “in-distribution” samples can be processed off-line, for example, pre-processed. For instance, the following pre-processing can be performed for each of a plurality of “in-distribution” (also referred to as “clean” or “normal”) images. An “in-distribution” image is run through the neural network and the activations at the internal nodes of the neural network are recorded or observed. In an embodiment, internal nodes include the nodes of the neural network excluding the output layer nodes and input layer nodes. The “in-distribution” image is perturbed with noise and the perturbed image is run through the neural network. The activations at the internal nodes of the neural network are recorded or observed. At each internal node, the difference in activations of the perturbed and corresponding unperturbed image is determined. The processing at 310 compares, at each internal node, the difference between the difference computed at 308 (for the input image) with those of the plurality of “in-distribution” images.

At 312, the method includes calculating or computing an anomaly score per input. For instance, the anomaly score can be a function of the activation differences computed at 310. In another aspect, the anomaly score can be a function of the p-value determined based on the activation differences computed at 310. For example, a p-value can be determined associated with each internal node. A combination of the differences at each internal node can be computed as an anomaly score for a given input. In another aspect, a particular internal node can be identified as having an anomaly. For instance, activations at the internal node for a plurality of inputs can be observed and/or compared to determine possible anomaly at that internal node.

In embodiments, the method can be performed for multiple inputs. For example, 50 input images, by way of example only. Those 50 input images are run through the neural network and their activation deltas between perturbed and unperturbed versions can be determined at each internal node. Those activation deltas can be compared with those of the “in-distribution” samples, for example, as described above, and for example, a p-value can be obtained at each internal node for each input based on the comparison. Internal nodes are also referred to as “nodes” in the following description. An iterative ascent algorithm can determine which of those 50 input images and which set of internal nodes are anomalous. For instance, initially, a subset of nodes that produced most anomalous activations is identified. For instance, those that have small p-value or large activation delta (e.g., based on or compared to a threshold value) can be selected or identified. From those identified nodes, a subset of images from the input images (e.g., 50 input images in this example) that are responsible for the anomalous activations (e.g., small p-values) in those identified nodes are selected or identified. This process iterates. For example, out of the subset images, a second set of nodes that are most anomalous are selected or identified (e.g., based on comparing their p-values to a threshold value or the threshold value). Then, using those second set of nodes, a second subset of images are selected, which are responsible for the anomaly in those nodes. Such iteration can continue, for example, with identifying third, fourth, fifth, and so forth set of nodes and subset of images. The iteration can continue until there is a convergence or until a criterion is met. For instance, a convergence occurs if the set of images remain the same over iterations and/or the set of nodes remain the same over the iterations. Another example of a convergence occurring can be if the set of images remain substantially the same over iterations (e.g., there is only a small number (e.g., a threshold number) of difference between the iterations) and/or the set of nodes remain substantially the same (e.g., there is only a small number (e.g., a threshold number) of difference between the iterations) over iterations. An example of a criterion can be a maximum number of iterations. In this way, in an embodiment, the method can identify a set of images in the input images that are out-of-distribution, and which set of internal nodes (e.g., which set of features in the set of images) are out-of-distribution, or not “normal”.

At 314, the method includes calculating or computing an anomaly score for a subset of inputs. For instance, the anomaly score can be the difference computed at 310 for a subset of inputs. The subset of inputs can be the set of images identified by running the iterative ascent algorithm as described above. For example, the method shown in FIG. 3 can be iterated for multiple inputs. Each of the anomaly score associated with the multiple inputs or a subset of multiple inputs can be combined (e.g., by averaging or using another computation) to compute the anomaly score for the subset of inputs. A subset scan methodology (e.g., FGSS algorithm) may treat an image as a ‘row’ of the FGSS framework and each node activation as a ‘column’. The anomaly score can represent or inform a degree of anomaly in the input.

Anomalies can be presented in a variety of datasets. Each dataset can run through the functionality of subset scanning in the representation space of models built using such dataset. In an aspect, the system may group datasets for consideration into four broad areas: Images, e.g., X-rays, human faces, or handwriting; audio, e.g., recorded speech, video, e.g., captioned video; tabular data, e.g., patterns of healthcare.

In the present disclosure, anomalies can include any one of: adversarial datapoints (data that is designed and intended to cause a misclassification in the model), new class label (a datapoint that belongs to a new class, i.e., a class that the model was not trained to identify), and generated datapoint (a datapoint that is obtained from a generative model trained based on knowledge of the background data).

The method allows for understanding how the perturbation changes the internal layers of a neural network. In embodiments, to detect “out-of-distribution' samples”, the non-parametric scan statistics and the iterative ascent algorithm that optimizes across subsets of images and subsets of nodes in a neural network can be applied on data coming from deep neural network. The data can be image data, audio data, video data, and/or another type of data. Combining the algorithms on data from deep neural network can provide ability to scan over groups of images to determine whether perturbations to those images create an anomalous response in the internal layers of the network. Those anomalous responses can be connected to images that are OOD, for example, adversarial images, new class images, or distribution shift over time.

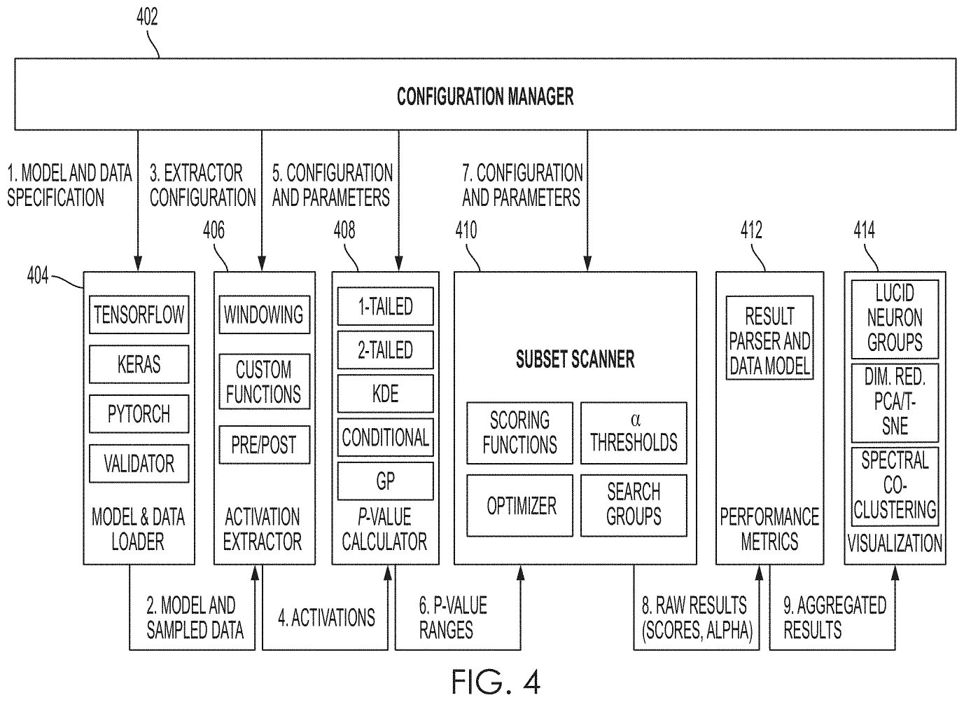

FIG. 4 is a diagram illustrating system components and dataflow, according to some embodiments. The components shown can include computer-implemented components, for instance, implemented and/or run on one or more processors or hardware processors, or coupled with one or more hardware processors. One or more processors, for example, may include components such as programmable logic devices, microcontrollers, memory devices, and/or other hardware components, which may be configured to perform respective tasks described in the present disclosure. Coupled memory devices may be configured to selectively store instructions executable by one or more processors.

A processor may be a central processing unit (CPU), a graphics processing unit (GPU), a field programmable gate array (FPGA), an application specific integrated circuit (ASIC), another suitable processing component or device, or one or more combinations thereof. The processor may be coupled with a memory device. The memory device may include random access memory (RAM), read-only memory (ROM) or another memory device, and may store data and/or processor instructions for implementing various functionalities associated with the methods and/or systems described herein. The processor may execute computer instructions stored in the memory or received from another computer device or medium.

Configuration manager 402 serves as an interface to the user for configuring the mode and parameters of operation of determining out-of-distribution images and/or nodes, e.g., the subset scanning (e.g., FGSS). The configuration manager 402 can provide samples from a dataset and provide the specifications of a model, e.g., a neural network model which data samples can be run through. The configuration manager may create live situations where known anomalies are present in small percentage of the data. Specifications of a model can include information such as the type of a model (e.g., neural network), how to read the model, how to run the model. For instance, the configuration manager 402 can provide input data such as input images for determining which of those input images, and which features (based on internal node anomaly) in those input images are out-of-distribution.

Model and Data loader 404 provides an extensible framework that loads the model and data based on the configuration provided by the configuration manager 402. An example of a model is a neural network, an autoencoder, and/or another. The system can support existing neural network frameworks such as, but not limited to, TensorFlow, pytorch, Keras, and their respective data loading formats.

Activation extractor 406 can extract activations data from the model (e.g., neural network) based on the specified configuration provided by the configuration manager 402. It passes the data (background, suspected anomalous and clean) through the model network (e.g., a neural network model) and extracts activations. For example, neural networks are characterized by activations in each nodes of the network. As a network may be composed of an arbitrary number of layers and nodes in each layer, extracting activations involves passing a set of input to the network and keeping the activation values from each activation. In embodiments, the activation extractor 406 receives extractor configuration and extracts activations corresponding to the way it has been configured. For example, the activation extractor 406 extracts activations from a set of “in-distribution” samples (also referred to above as background) and input data (referred to as “suspected anomalous and clean”) for which “out-of-distribution” determination is being made. The activation extractor 406 may receive extractor configuration from the configuration manager and extract activations corresponding to the way it has been configured (e.g., according to the received configurations). Configurations may specify windowing parameters if any (e.g., layers of nodes to extract activations), what custom functions to use if any, whether to use pre-activation or post-activation function values, and/or others. For instance, a custom function can specify a linear transformation to apply on the extracted activations, for example, for scaling values. Pre-activation or post-activation configuration specifies whether the activations are used before the activation function is applied at a node or after the activation function if applied at the node. For example, a default configuration can be post-activation.

P-value calculator 408 calculates p-value ranges for clean and anomalous records using the background records. For instance, any one or more of implementations such as, but not limited to, 1 and 2 tailed tests as well as from a kernel density estimate (KDE), can be implemented to calculate p-values or p-values ranges. Conditional distribution and GP are other examples of calculating p-values. Conditional p-value calculation calculates p-values conditioned on their labels of the data. For example, a data of digits (0-9) may have p-values calculated for each label. Instead of computing what proportion of the background of activations are greater than an activation under evaluation for all the input (e.g., which yields the p-value), the p-value calculator 408 may first group the input and background according to their labels or predicted labels, and then compute the p-values for each group. GP refers to Gaussian Process. P-value calculator 408 can receive configuration and/or parameters. Such configuration and/or parameters may specify which one or more of such functions can be employed in p-value calculation.

Subset scanner 410 implements FGSS with scoring functions as described above. For example, given the p-values determined by the p-value calculator 408, an iterative ascent algorithm can be run or implemented to identify which subset of input data and which subset of nodes are out-of-distribution (e.g., anomalous). The subset scanner 410 uses scoring functions and optimizes over search groups. The subset scanner 410 uses an alpha threshold to compare with the p-values for determining anomaly. One or more alpha values can be configured, for measuring against the p-values. For example, there may be 100 different alpha thresholds, which may be specific to iterative ascent algorithms. Scoring functions include different types of non-parametric scan statistics. The subset scanner 410 can receive configuration and/or parameters, which can specify which one or more scoring functions can be used in subset scanning or optimizing.

Performance metrics module 412 calculates performance metrics from raw results from the subset scanner 410, such as precision, recall, and detection power. For example, precision can be computed as TP/(TP+FP) of inputs. Recall can be computed as TP/(TP+FN) of the inputs. TP refers to True Positives, FP refers to False Positives, TN refers to True Negatives, and FN refers to False Negatives. For instance, results from the subset scanner 410 can be compared with known results to determine TP, FP, TN and FNs. In detection power, an area under the ROC curve of where scores from noised input are classed as positive and scores from the clean inputs are classes as negative is used to effectively characterize how well the two classes are separated given the distribution of their scores. The performance metrics module 412 can be a user interface module, e.g., a graphical user interface (GUI).

Visualization module 414 visualizes results and aggregated results such as showing anomalous nodes comparisons with spectral co-cluster of nodes. The visualization can aid in identifying correlations of “anomalies” with certain representation. For example, representations can include, but are not limited to, lucid neuron groups, dimension reduction principal component analysis (PCA), and spectral co-clustering. The visualization module 414 can be a part of the GUI of the performance metrics module 412.

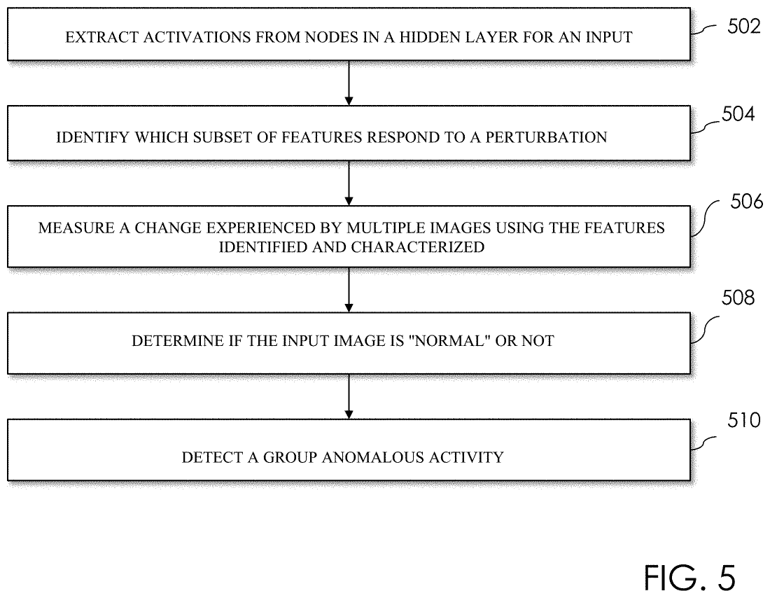

FIG. 5 is a flow diagram illustrating a method in one embodiment. The method, for example, provides for improved quantification, detection, and characterizing of out-of-distribution (OOD) of a set of inputs that are generated by an alternative process (e.g., anomalies, outliers, adversarial attacks, human input errors, etc.). The method can use a combination of detection under perturbations and subset scanning algorithms. The method can be implemented and/or executed on one or more processors such as hardware processors.

At 502, the method can include extracting activations from nodes in hidden layers (internal layers) of a neural network for each input. For example, activation values can be extracted from an internal node of a neural network executing an activation function.

At 504, the method can include identifying which subset of features of the input (e.g., image) respond to a perturbation. For example, a degree of difference in activations of perturbed and un-perturbed data in the internal nodes of the neural network identify whether the input such as an image respond to a perturbation.

At 506, the method can include measuring a change experienced by multiple input (e.g., multiple images) using the features (e.g., internal nodes) identified and/or characterized. For example, the difference in activations at each internal node identified at 504 can be measured for multiple input (e.g., multiple images).

At 508, the method can include determining if the input (e.g., input image) is “normal” or not based on the measure of change in the activations under the presence of perturbations.

At 510, the method can include detecting a group anomalous activity at perturbation level responsive to determining that the anomalies persist across multiple inputs. For example, in an embodiment, given a perturbation or perturbation level injected to multiple inputs, and determining that anomalous activity persists with that perturbation across the multiple input, the method may detect an anomalous activity at that perturbation level In an embodiment, detecting out-of-distribution (OOD) anomaly in a neural network can include injecting controlled perturbations to the data such as pixels of input sources. Input sources can include images (e.g., X-rays, human faces, or handwriting), audio (e.g., recorded speech), video (e.g., captioned video), tabular data (e.g., patterns of healthcare), and/or others.

In an embodiment, a response activation subset scan (RASS) looks for features (node activations) that have an anomalous response due to the noise injected to the input.

In an embodiment, activations can be extracted from a neural network, characterized as belonging to H0 (null hypothesis) or H1 (alternative hypothesis) distributions. P-values can also be computed. The computed p-values can be scored using a non-parametric scan statistic. The highest scoring subsets of the activations can be identified.

In an embodiment, an anomalous set of images or nodes can be detected among a first dataset of images using subset scanning.

In an embodiment, the method may also include generating enriched results with interactive visualization of anomalous nodes in the model space and inner layers of the neural networks.

The method can be used to learn to detect adversarial noise where an attacker has made alterations (e.g., slight alterations) to the input in order to intentionally trick the network into providing the wrong response. The method can also be used to learn to detect a new class label (or distribution shift). For example, consider a system designed to classify cancer types. The method can also be used in programming the machine learning system to detect out-of-distribution samples generally, e.g., simple mistakes in data streams where completely different samples are provided to the network.

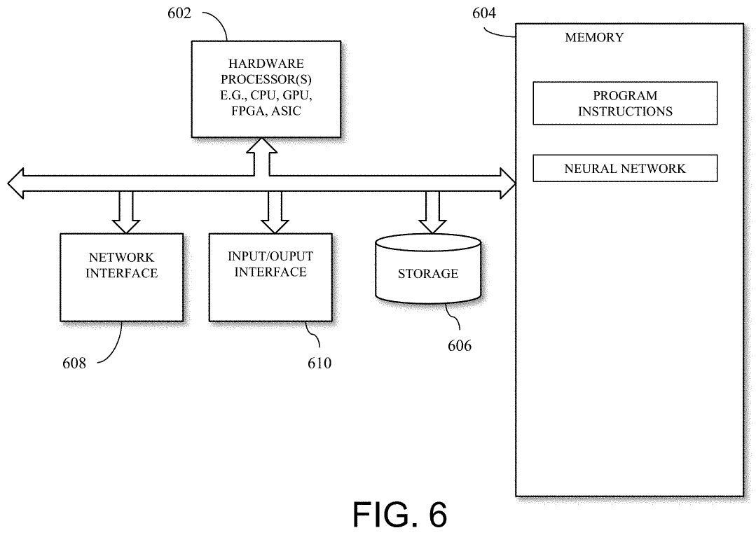

FIG. 6 is a diagram showing components of a system in one embodiment that can provide an out-of-distribution detection by perturbation. One or more hardware processors 602 such as a central processing unit (CPU), a graphic process unit (GPU), and/or a Field Programmable Gate Array (FPGA), an application specific integrated circuit (ASIC), and/or another processor, may be coupled with a memory device 604, and detect anomalies in features of input data to a neural network. A memory device 604 may include random access memory (RAM), read-only memory (ROM) or another memory device, and may store data and/or processor instructions for implementing various functionalities associated with the methods and/or systems described herein. One or more processors 602 may execute computer instructions stored in memory 604 or received from another computer device or medium. A memory device 604 may, for example, store instructions and/or data for functioning of one or more hardware processors 602, and may include an operating system and other program of instructions and/or data. One or more hardware processors 602 may receive input, run the input through a neural network and extract activations of nodes of one or more hidden layers of the neural network. One or more hardware processors 602 may also noise the input, run the noised input through the neural network and extract activations of nodes of one or more hidden layers of the neural network. The activations can be compared, and anomaly score can be computed. The input data may be stored in a storage device 606 or received via a network interface 608 from a remote device, and may be temporarily loaded into a memory device 604. The neural network may be stored on a memory device 604, for example, for execution by one or more hardware processors 602. One or more hardware processors 602 may be coupled with interface devices such as a network interface 608 for communicating with remote systems, for example, via a network, and an input/output interface 610 for communicating with input and/or output devices such as a keyboard, mouse, display, and/or others.

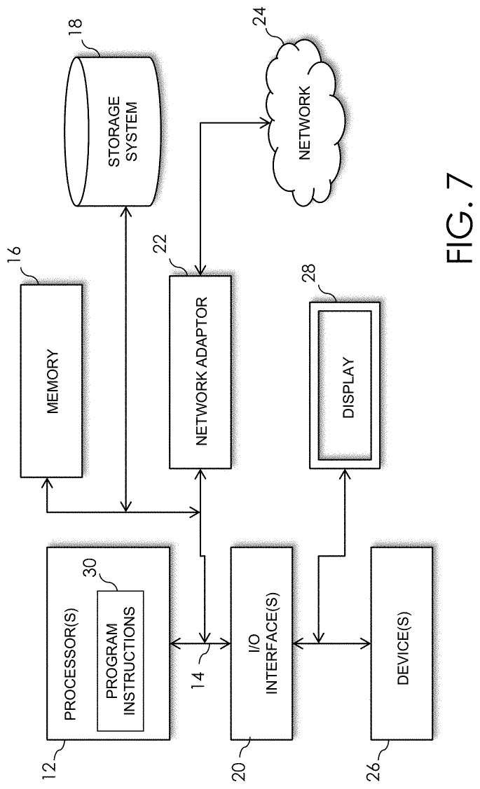

FIG. 7 illustrates a schematic of an example computer or processing system that may implement a system in one embodiment. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 7 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 30 that performs the methods described herein. The module 30 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “or” is an inclusive operator and can mean “and/or”, unless the context explicitly or clearly indicates otherwise. It will be further understood that the terms “comprise”, “comprises”, “comprising”, “include”, “includes”, “including”, and/or “having,” when used herein, can specify the presence of stated features, integers, steps, operations, elements, and/or components, but do not preclude the presence or addition of one or more other features, integers, steps, operations, elements, components, and/or groups thereof. As used herein, the phrase “in an embodiment” does not necessarily refer to the same embodiment, although it may. As used herein, the phrase “in one embodiment” does not necessarily refer to the same embodiment, although it may. As used herein, the phrase “in another embodiment” does not necessarily refer to a different embodiment, although it may. Further, embodiments and/or components of embodiments can be freely combined with each other unless they are mutually exclusive.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method comprising:
extracting a first set of activations from nodes in a hidden layer of a neural network for an input;
adding noise to the input;
extracting a second set of activations from the nodes in the hidden layer of the neural network for the noised input;
determining a difference between the first set of activations and the second set of activations at the nodes;
comparing the difference with a difference computed using in-distribution samples at the nodes; and
determining an anomaly score for the input based on the comparison.

2. The method of claim 1, wherein the method is performed for multiple inputs.

3. The method of claim 2, further including determining out-of-distribution images and internal nodes of the neural network with anomalous activations in the out-of-distribution images, by performing an iterative ascent algorithm including iteratively selecting a subset of nodes with anomalous activations and a subset of images responsible for the subset of nodes' anomalous until the subset of inputs converges between iterations.

4. The method of claim 1, wherein the input includes image data.

5. The method of claim 1, wherein the input includes audio data.

6. The method of claim 1, wherein the input includes video data.

7. The method of claim 1, further including providing a visualization associated with the nodes in the hidden layer of the neural network and the anomaly score.

8. A computer program product comprising a computer readable storage medium having program instructions embodied therewith, the program instructions executable by a device to cause the device to:
extract a first set of activations from nodes in a hidden layer of a neural network for an input;
add noise to the input;
extract a second set of activations from nodes in the hidden layer of a neural network for the noised input;
determine a difference between the first set of activations and the second set of activations;
compare the difference with a difference computed using in-distribution samples; and
determine an anomaly score for the input based on the comparison.

9. The computer program product of claim 8, wherein the device is caused to perform the program of instructions for multiple inputs.

10. The computer program product of claim 8, wherein the device is further caused to determine out-of-distribution images and internal nodes of the neural network with anomalous activations in the out-of-distribution images, by performing an iterative ascent algorithm including iteratively selecting a subset of nodes with anomalous activations and a subset of images responsible for the subset of nodes' anomalous until the subset of inputs converges between iterations.

11. The computer program product of claim 8, wherein the input includes image data.

12. The computer program product of claim 8, wherein the input includes audio data.

13. The computer program product of claim 8, wherein the input includes video data.

14. The computer program product of claim 8, wherein the device is further caused to provide a visualization associated with the nodes in the hidden layer of the neural network and anomaly score.

15. A system comprising:
a hardware processor; and
a memory coupled with the hardware processor,
the hardware processor configured to at least:
extract a first set of activations from nodes in a hidden layer of a neural network for an input;
add noise to the input;
extract a second set of activations from nodes in the hidden layer of a neural network for the noised input;
determine a difference between the first set of activations and the second set of activations;
compare the difference with a difference computed using in-distribution samples; and
determine an anomaly score for the input based on the comparison.

16. The system of claim 15, wherein the hardware processor is further configured to determine an anomaly score for a subset of multiple inputs.

17. The system of claim 16, wherein the hardware processor is further configured to determine out-of-distribution images and internal nodes of the neural network with anomalous activations in the out-of-distribution images, by performing an iterative ascent algorithm including iteratively selecting a subset of nodes with anomalous activations and a subset of images responsible for the subset of nodes' anomalous until the subset of inputs converges between iterations.

18. The system of claim 15, wherein the input includes image data.

19. The system of claim 15, wherein the input includes audio data.

20. The system of claim 15, wherein the input includes video data.
